(19) United States
(12) Patent Application Publication
(10) Pub. No.: US 2004/0178011 A1
(43) Pub. Date: Sep. 16, 2004

(54) Electric tri-cycle

(76) Inventor: Thomas E. Lenkman, St. Charles, MO (US)

Correspondence Address: Henry W. Cummings, 3313 W. Adams St., St. Charles, MO, 63301, US

(21) Appl. No.: 10/385,358

(22) Filed: Mar. 11, 2003

(51) Int. Cl. B62K 5/02; B62D 61/06

(52) U.S. Cl. 180/210

(57) ABSTRACT

The present invention comprises a three-wheeled vehicle which employs batteries and an electric motor for quiet, safe power to drive the vehicle. Certain components of the vehicle are designed to simulate a full-sized three wheel motorcycle. A charger unit allows the batteries to be recharged from any household wall outlet such as 120 or 230 Volts. The vehicle of the present invention employs batteries and an electric motor for quiet, safe power. Selected components of the present invention are intentionally designed to simulate a full-sized three-wheel motorcycle. A charger arrangement allows the batteries to be recharged from a 120 Volt wall outlet.

### I. FIELD OF THE INVENTION

This invention relates to an electric scooter with simulated motorcycle parts.

### II. BACKGROUND OF THE INVENTION

U.S. Pat. No. 3,117,648 discloses a three-wheeled electrically powered vehicle. This vehicle is a larger, more complicated vehicle intended for use as a golf cart or industrial transportation. Furthermore, it does not attempt to simulate a motorcycle.

U.S. Pat. Nos. 4,020,914 and 4,088,199 disclose a stabilized three wheeled vehicle. While this vehicle has three wheels, the single wheel is in the rear and is driven by a gasoline engine. It is also intended for on road use in place of an automobile or motorcycle.

U.S. Pat. No. 4,237,995 discloses a three-wheeled motor powered vehicle. This vehicle is powered by a gasoline engine which is designed to be started by pedaling. It has a large bench seat, a windshield and all overhead cover. It is not intended to resemble a motorcycle.

U.S. Pat. No. 4,313,517 discloses a three-wheeled vehicle powered by an electric motor. This vehicle has a large bench seat, a windshield and an overhead cover. It is not intended to resemble a motorcycle.

U.S. Pat. Nos. 5,314,207 and 5,505,493 disclose bicycles with simulated motorcycle parts. While designed to resemble a motorcycle, these vehicles have two wheels and derive their only motive power from the muscles of the rider.

U.S. Pat. No. 6,120,345 discloses a ride-on vehicle with a free-floating wheel. This electrically powered vehicle is designed as a children's toy to resemble a two-wheeled motorcycle. However, it uses two outrigger type wheels in addition to the motorcycle wheels to provide its motive force.

### III. SUMMARY OF THE INVENTION

### A. Objects of the Invention

One object of the present invention is to provide a vehicle to transport a person from place to place.

Another object of the present invention is to use a silent electric motor for power.

Another object of the present invention is to simulate a motorcycle in order to provide an enjoyable form of transportation.

Other objects will be apparent from the following Descriptions and Drawings.

### B. Summary

The present invention comprises a three-wheeled vehicle which employs batteries and an electric motor for quiet, safe power to drive the vehicle. Certain components of the vehicle are designed to simulate a full-sized three wheel motorcycle. A charger unit allows the batteries to be recharged from any household wall outlet such as 120 or 230 Volts.

### IV. THE DRAWINGS

FIG. 1 is a perspective side view of the present invention.

FIG. 2 is a perspective rear view of the present invention.

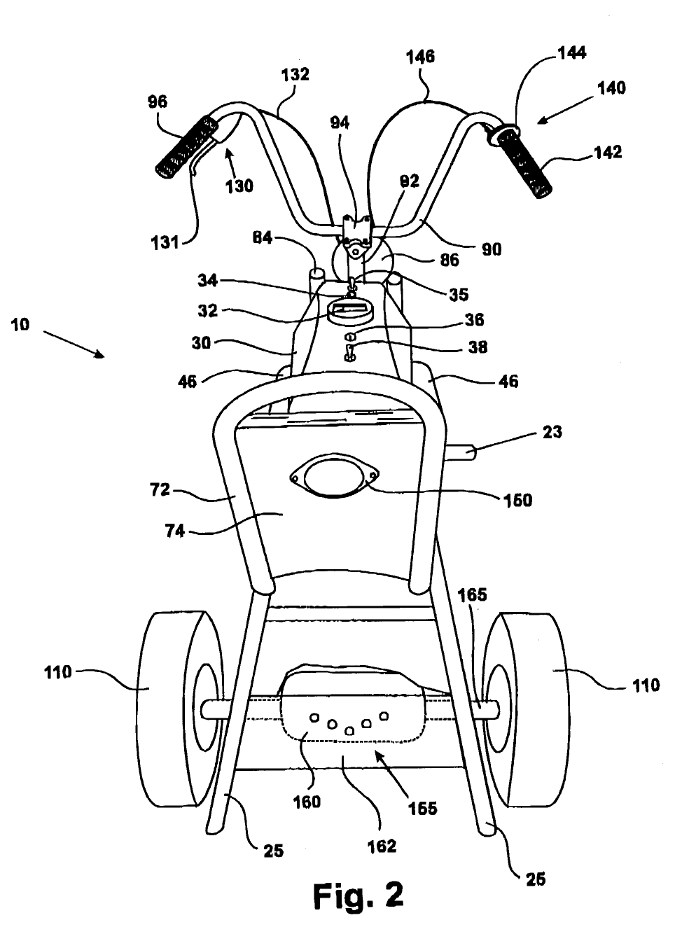

### V. DESCRIPTION OF PREFERRED EMBODIMENTS

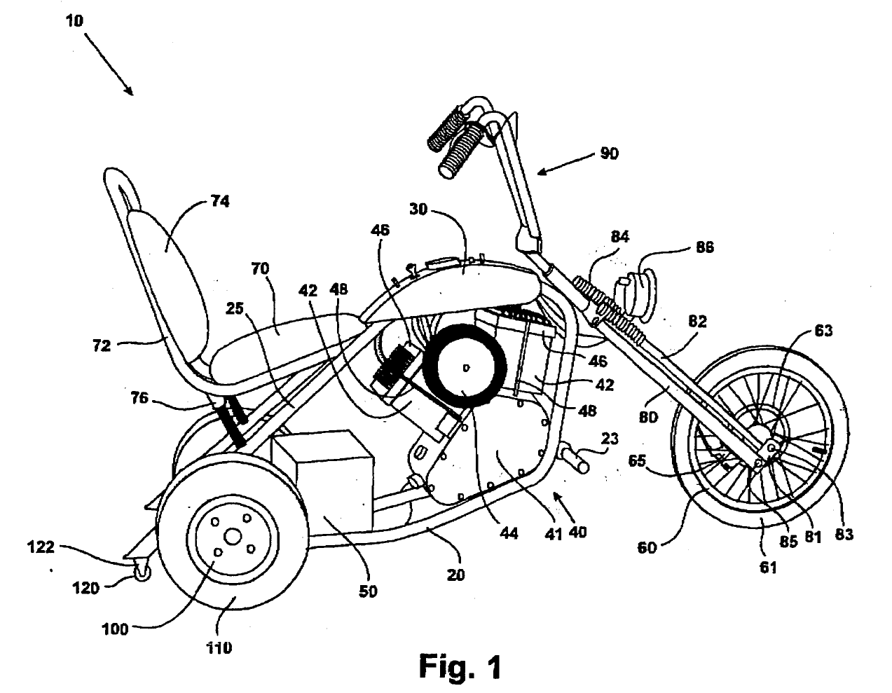

FIG. 1 shows a perspective view of the present invention generally at 10.

Major structural components of the present invention comprise lower frame 20, upper frame 25, steering forks 80, front suspension 82. and seat/backrest frame 72. The structural members are made of welded aluuminum alloy or welded steel preferably tubing.

Front tire 61 is mounted to spoked wheel 60. Front suspension 82 and the wheel and tire assembly are mounted to pivoting member 81 at 83, which pivots at 85. This allows the front wheel and tire assembly to move in relation to steering forks 80. The motion of front suspension 82 is dampened by front shock absorbers 84, which may be elastomeric or mechanical springs. Also mounted to steering forks 80 is headlight 86.

Handlebars 90 are mounted to the tops of steering forks 80 by means of handlebar neck 92 and handlebar clamp 94. Mounted to handlebars 90 are grip 96, hand brake assembly 130. and speed control assembly 140.

Simulated tank 30 is mounted to upper frame 25 and contains the following controls and indicators. Headlight switch 35 applies electrical power to headlight 86 and running lights 155. Horn button 34 applies electrical power to an audible horn device. A simulated gas cap 32 contains a battery level indicator 33. Key switch 36 acts as a master switch and allows the vehicle to be secured against unauthorized use. Forward/reverse selector switch 38 allows the user to choose the direction of travel.

Mounted to lower frame 20 is simulated engine 40, which comprises electronics compartment 41, batteries 42, battery charger cord reel 44, and simulated cylinder heads 46. Electronics compartment 41 may be made of metal or high-impact plastic. It provides a housing for the lower electronic components, including the battery charger. Batteries 42 are commercially available 12-volt units. which may be lead-acid, gel-cell, or any suitable type and rating. Batteries 42 are wired in series, providing 24 volts, and are secured to electronics compartment 41 by means of simulated cylinder heads 46, which are fastened to electronics compartment 41 with battery hold-down rods 48.

Simulated cylinder heads 46 are preferably made of high impact plastic or any other material having suitable insulating qualities. Battery hold-down rods 48 are made of strong plastic or metal such as steel or aluminum alloy.

Battery charger cord reel 44 is designed to simulate an engine air filter. It is comprised of a spring-wound reel, which contains sufficient electrical cord to reach a nearby wall socket.

Foot pegs 23 are made of aluminum alloy or steel tubing, attached to lower frame 20 with mechanical fasteners which allow adjustability, to lower frame 20 and either coated with a non-skid compound or tape, or capped with rubber.

Wheelie wheel brackets 122 are made of steel aluminum alloy or other metal and are mounted to lower frame 20 by means of sheet metal screws, nuts and bolts, or other suitable fasteners. Wheelie wheels 120 are small rubber wheels rotationally mounted to wheelie wheel brackets 122. The purpose of wheelie wheels 120 is to prevent the user from overbalancing the vehicle 10 and causing possible injury or damage to equipment.

Beverage cooler 50 is removably mounted to lower frame 20. It may be of any suitable size and configuration to contain ice and a reasonable amount of beverage or food.

Seat/backrest frame 72 is pivotably Inaunted to upper frame 25 at its forward end. Its rear end is supported by seat shock absorbers 76 which serve to cushion the user from bumps in the road. Seat 70 and backrest 74 are made of any suitable padded material such as foam rubber and covered with suitable upholstery. They are mounted to seat/backrest frame 72 by means of screws, nuts and bolts. or other suitable fasteners. Backrest 74 provides a mounting point for reflector 150.

Rear tires 110 are mounted to rear wheels 100, which in turn are mounted to axle 165. Axle 165 is mounted to lower frame 25 and connected to electric motor 160, mounted to lower frame 25. Motor cover 162 provides protection for motor 160, as well as a mounting point for lights 155.

In use, the user first inserts a key into key switch 36 and turns it to the “on” position. This applies electrical power to all electricalsy stems. The forward/reverse selector switch 38 allows the user to select the direction in which the tricyle wiil travel. the speed is determined by the position of the speed control rheostat 144. When the user turns twist grip 142, electrical power is applied to electric motor 160 via speed control cable 146, which turns axle 165 and rear wheels 100 and rear tires 110, causing motion in the chosen direction. Turning twist grip 142 to a greater or lesser degree will vary speed of travel.

The electric motor 16c incorporates a brake that is automatically applied when the trist grip 142 is returned to its spring loaded rest position. The auxiliary front brake is applied by squeezing brake handle 131, which moves brake cable 132. This actuates brake calipers 65 which appy pressure on disc brake 63.

VI. What is claimed is:

1. An electrically powered vehicle comprising:
a rigid frame,
an articulated front suspension,
a simulated engine,
a simulated gas tank,
electric motor driven rear wheels,
and means to control said vehicle.

2. An electrically powered vehicle according to claim 1 having a rigid frame to which are mounted other components.

3. An electrically powered vehicle according to claim 1 including an articulated front suspension comprising steerable forks, suspension members, handlebars, and a braking system. and a headlight.

4. An electrically powered vehicle according to claim 3 wherein said articulated front suspension has steerable forks to which is mounted a spoked motorcycle-style wheel and tire.

5. An electrically powered vehicle according to claim 3 wherein said articulated front suspension has suspension members supported by springs to provide a softer ride.

6. An electrically powered vehicle according to claim 3 wherein said articulated front suspension has handlebars which provide the rider with control over the vehicle's direction of travel.

7. An electrically powered vehicle according to claim 6 wherein said handlebars also contain means to control the vehicle's speed.

8. An electrically powered vehicle according to claim 7 wherein said handlebars also contain means to actuate a vehicle braking system.

9. An electrically powered vehicle according to claim 8 wherein said articulated front suspension has mopunted threreon said braking system comprising a handlebar mounted brake lever, a wheel-mounted disc brake, brake calipers and a cable to transfer brake lever motion to the brake calipers.

10. An electrically powered vehicle according to claim 3 wherein said articulated front suspension has an operator-controlled headlight.

11. An electrically powered vehicle according to claim 1 wherein said simulated engine resembles an actual motorcycle engine.

12. An electrically powered vehicle according to claim 11 wherein said simulated engine comprises batteries, an electronics compartment, and a storage reel for an electrical cord.

13. An electrically powered vehjcle according to claim 1 wherein said simulated engine has a plurality of batteries to provide electrical power to the vehicle.

14. An electrically powered vehicle according to claim 13 wherein said simulated engine has an electronics compartment containing circuitry for recharging batteries.

15. An electrically powered vehicle according to claim 14 wherein said simulated engine has a spring wound storage reel containing an electrical cord to facilitate battery charging.

16. An electrically powered vehicle according to claim 1 wherein said simulated gas tank houses controls and indicators.

17. An electrically powered vehicle according to claim 16 wherein said controls and indicators include a key switch, a headlight switch, a horn button, a motor direction switch, and a battery charge indicator,

18. An electrically powered vehicle according to claim 1 wherein said electric motor driven rear wheels are mounted to said rigid frame and are turned by an electric motor also mounted to said rigid frame.

19. An electrically powered vehicle according to claim 1 wherein a beverage cooler is mounted to the rigid frame.

20. An electrically powered vehicle according to claim 1 wherein said means to ensure rider safety and control comprise seat position, wheelie wheels, and the seat's suspension.

21. An electrically powered vehicle according to claim 20 wherein said seat position places the rider's weight forward of the rear wheels.

22. An electrically powered vehicle according to claim 21 wherein said seat position helps to limit said “wheelies” wheels keeping the front wheel in contact with the ground to ensure driver control.

23. An electrically powered vehicle according to claim 22 wherein said wheelie wheels act as a positive means to limit the front wheel's distance from the ground.

24. An electrically powered vehicle according to claim 20 wherein said seat suspension allows vertical motion of the seat and rider.

25. An electrically powered vehicle according to claim 24 wherein said seat suspension which increases comfort and safety by tending to ensure that the driver remains seated on the vehicle in the event of rough terrain.

26. An electrically powered vehicle according to claim 12 wherein said electronics compartment is configured to resenble and engine crankcase.

26. An electrically powered vehicle according to claim 12 wherein said wherein said batteries are mounted in a manner to resemble engine cylinders.

27. An electrically powered vehicle according to claim 26 wherein said wherein said batteries are mounted in a manner to resemble engine cylinders of a V-Twin motor cycle engine.

28. An electrically powered vehicle according to claim 15 wherein said wherein said reel is mounted to resemble a motor cycle air cleaner.
